(19) United States
(12) Patent Application Publication
(10) Pub. No.: US 2014/0200983 A1
(43) Pub. Date: Jul. 17, 2014

(54) SYSTEM AND METHOD FOR PROVIDING FRANCHISE REWARDS

(71) Applicants: Steve Bacastow, Cumming, GA (US); Robert Sadeckas, Lakewood, OH (US)

(72) Inventors: Steve Bacastow, Cumming, GA (US); Robert Sadeckas, Lakewood, OH (US)

(21) Appl. No.: 14/155,001

(22) Filed: Jan. 14, 2014

Related U.S. Application Data
(60) Provisional application No. 61/762,042, filed on Feb. 7, 2013.
(60) Provisional application No. 61/752,330, filed on Jan. 14, 2013.

(51) Int. Cl. G06Q 30/02; G06Q 20/36

(52) U.S. Cl. CPC G06Q 30/0227; G06Q 20/36
USPC 705/14.28

(57) ABSTRACT

Embodiments are directed to sharing a loyalty and rewards program across multiple merchants. In one scenario, a computer system receives an indication that a user has redeemed a specified number of loyalty points using a redemption code for items at a second merchant, where the user has received at least some loyalty points from a first merchant as the result of a prior purchase, and where the user's loyalty points are stored in loyalty points store. The computer system then debits, from the user's store of loyalty points, the specified number of loyalty points redeemed by the user, credits the second merchant with at least some of the value associated with the items paid for using the stored loyalty points, and debits the first merchant for at least some of the value associated with the items paid for using the user's stored loyalty points.

### CROSS-REFERENCE TO RELATED APPLICATIONS

This application claims priority to and the benefit of U.S. Provisional App. No. 61/762,042, entitled “SYSTEM AND METHOD FOR PROVIDING FRANCHISE REWARDS, filed on Feb. 7, 2013, and further claims priority to and the benefit of U.S. Provisional App. No. 61/752,330, entitled “SYSTEM AND METHOD FOR PROVIDING FRANCHISE REWARDS, filed on Jan. 14, 2013, both of which applications are incorporated by reference herein in their entirety.

### COPYRIGHT NOTICE

A portion of the disclosure of this patent document may contain material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

Embodiments of the present invention relate to a system and method for the inter-company exchange of value related to a loyalty-reward redemption event. More specifically, embodiments relate to a method for ensuring the equitable exchange of value between and among merchants that participate in a common loyalty rewards program where there may be no common ownership between or among the merchants.

### BACKGROUND OF THE INVENTION

There has been a significant increase in the use of loyalty rewards programs by merchants as a means of encouraging repeat business. Most large, multi-location retailers (e.g. Best Buy, Dick's, Kroger) offer programs whereby their customers may accrue points associated each purchased product or service. These points can later be redeemed for value in the form of discounts, coupons, or free products. For example, Kroger allows its customers to redeem loyalty points to purchase gasoline at a discount. And, Dick's sends its customers coupons based on their accrued loyalty points. While these programs are well established for large, multi-location retailers, the smaller retailers (e.g. franchisees such as Dairy Queen, Dunkin Donuts, Arby's, and McDonalds) have struggled to create similar programs due multiple limitations including the absence of common point of sale (POS) systems and fragmented store ownership.

For example, large merchant chains generally enjoy the advantages of common point-of-sale (POS) systems that can be integrated into common back-office systems. These, in turn, can facilitate standard, loyalty-reward programs that span across commonly owned retail locations. However, small merchants are typically limited by their use of non-standard POS and back-office systems, and are further limited due to the non-common ownership structure of their businesses. As a result, company-owned stores with standardized POS systems are in a position to quickly innovate in areas such as loyalty-rewards as compared to smaller merchants that often share only a common brand with limited or no shared store ownership.

As shown in FIG. 1, there are two separate merchant loyalty programs, each used by a single merchant. In one embodiment, Merchant A enrolls into Loyalty Program A (using step 1a). Next, Customer A enrolls in Loyalty Program A (using step 2a.). Next, Customer A receives credentials from Loyalty Program A (using step 3a). Next Customer A uses Loyalty Program A credentials to shop or redeem at Merchant Location A (using step 4a). Last, loyalty points are accrued or redeemed by Merchant A using Loyalty Program A (using step 5a). In another embodiment, an identical process is followed for Merchant B, where Merchant B enrolls into Loyalty Program B (using step 1b).

Next, Customer A enrolls in Loyalty Program B (using step 2b). Next, Customer A receives credentials from Loyalty Program B (using step 3b). Next, Customer A uses Loyalty Program B credentials to shop or redeem at Merchant Location B (using step 4b). Last, loyalty points are accrued or redeemed by Merchant B using Loyalty Program B (using step 5b). Customer A is thus required to maintain two separate sets of loyalty program credentials. Moreover, loyalty points are fragmented between the two loyalty programs (A and B) and merchants which might otherwise share a common brand cannot themselves participate in a shared loyalty program.

### SUMMARY OF THE INVENTION

Embodiments described herein provide methods and systems that allow participating independent merchants to participate in a common loyalty program even if the merchants are not commonly owned and irrespective of whether the merchants use a common POS system or common back-office system.

In an embodiment of the present invention, the system can be configured to allow a customer to accrue points at one merchant and redeem points at another merchant.

In another embodiment of the invention, the system can configured to facilitate an exchange-value calculation that converts redeemed loyalty points into a financial value that can be used as a basis for merchant settlement.

In another embodiment, a computer system performs a method for sharing a loyalty and rewards program across a plurality of merchants. The computer system receives an indication that a user has redeemed a specified number of loyalty points using a redemption code for items at a second merchant, where the user has received at least some loyalty points from a first merchant as the result of a prior purchase, and where the user's loyalty points are stored in loyalty points store. The computer system then debits, from the user's store of loyalty points, the specified number of loyalty points redeemed by the user, credits the second merchant with at least some of the value associated with the items paid for using the stored loyalty points, and debits the first merchant for at least some of the value associated with the items paid for using the user's stored loyalty points.

In yet another embodiment, a computer system performs an alternative method for sharing a loyalty and rewards program across a plurality of merchants. The computer system receives an input from a user indicating that a specified number of stored loyalty points are to be used to at least partially pay for a specified item at a second merchant, where at least some of the stored loyalty points were received from a first merchant as the result of a prior purchase. The computer system then generates a redemption code that is configured to redeem the specified number of loyalty points to at least partially pay for the specified item at the second merchant and sends the redemption code to a second computer system, where the user's store of loyalty points is debited by the specified number of loyalty points, the second merchant is credited with at least a portion of the value associated with the items paid for using the stored loyalty points, and the first merchant is debited for at least a portion of the value associated with the items paid for using the user's stored loyalty points. The computer system also receiving an indication that the specified number of loyalty points was redeemed and that the specified item is at least partially paid for.

In this manner, a flexible method may be provided for merchants that are not commonly owned to share a common loyalty program. Embodiments of the present invention are described below by way of illustration. Other approaches to implementing the present invention and variations of the described embodiments may be constructed by a skilled practitioner and are considered within the scope of the present invention.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which

FIG. 1 (PRIOR ART) shows the limitations of the current art whereby a customer enrolls in separate loyalty programs for each merchant.

FIG. 2 shows an example proposed whereby the merchants and customer can participate equitably in a common loyalty-redemption program.

FIG. 3 shows an embodiment in which customer's loyalty points are accrued at a first store, redeemed at a second store using a perishable QR code.

FIG. 4 shows a set of exemplary database tables may be used in various embodiments herein.

FIG. 5 shows an example embodiment wherein a customer shops at several stores and redeems an offer based on a campaign.

FIG. 6 illustrates a computer architecture in which embodiments described herein may operate including embodiments for sharing a loyalty and rewards program across multiple merchants.

FIG. 7 illustrates a flowchart of a method for sharing a loyalty and rewards program across multiple merchants.

FIG. 8 illustrates a flowchart of an alternative method for sharing a loyalty and rewards program across multiple merchants.

### DETAILED DESCRIPTION OF THE INVENTION

Embodiments described herein provide methods and systems that allow participating independent merchants to participate in a common loyalty program even if the merchants are not commonly owned and irrespective of whether the merchants use a common POS system or common back-office system.

In an embodiment of the present invention, the system can be configured to allow a customer to accrue points at one merchant and redeem points at another merchant.

In another embodiment of the invention, the system can configured to facilitate an exchange-value calculation that converts redeemed loyalty points into a financial value that can be used as a basis for merchant settlement.

In another embodiment, a computer system performs a method for sharing a loyalty and rewards program across a plurality of merchants. The computer system receives an indication that a user has redeemed a specified number of loyalty points using a redemption code for items at a second merchant, where the user has received at least some loyalty points from a first merchant as the result of a prior purchase, and where the user's loyalty points are stored in loyalty points store. The computer system then debits, from the user's store of loyalty points, the specified number of loyalty points redeemed by the user, credits the second merchant with at least some of the value associated with the items paid for using the stored loyalty points, and debits the first merchant for at least some of the value associated with the items paid for using the user's stored loyalty points.

In yet another embodiment, a computer system performs an alternative method for sharing a loyalty and rewards program across a plurality of merchants. The computer system receives an input from a user indicating that a specified number of stored loyalty points are to be used to at least partially pay for a specified item at a second merchant, where at least some of the stored loyalty points were received from a first merchant as the result of a prior purchase. The computer system then generates a redemption code that is configured to redeem the specified number of loyalty points to at least partially pay for the specified item at the second merchant and sends the redemption code to a second computer system, where the user's store of loyalty points is debited by the specified number of loyalty points, the second merchant is credited with at least a portion of the value associated with the items paid for using the stored loyalty points, and the first merchant is debited for at least a portion of the value associated with the items paid for using the user's stored loyalty points. The computer system also receiving an indication that the specified number of loyalty points was redeemed and that the specified item is at least partially paid for.

The following discussion refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

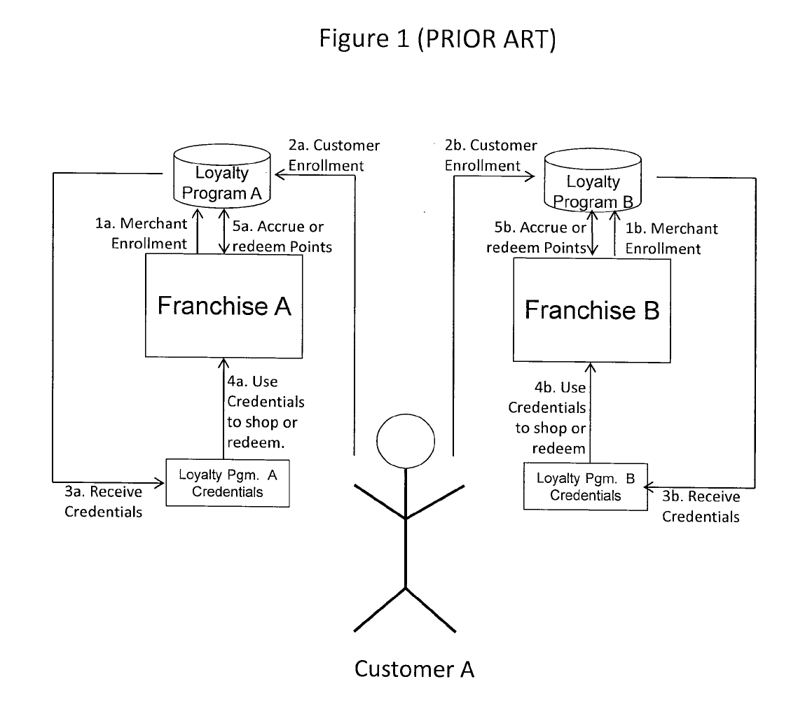

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

As will be described herein, a rewards and loyalty program may be shared between many different merchants. These merchants may be part of the same franchise or store name, or may be different stores entirely. Indeed, the merchants need not be stores, but may be restaurants, service providers, online retailers, or any other person or entity that is selling or providing goods and wishes to create and maintain a customer base using rewards and/or loyalty points. The loyalty points may be awarded to users when they make purchases with the merchant or when the otherwise interact with the merchant in a way that would cause the merchant to bestow loyalty points. For example, a merchant may give rewards (such as coupons, discounts, etc.) or loyalty points to users who give the merchant positive appraisals on websites, or who agree to participate in opt-in advertising from the merchant or sign up for an email newsletter or perform some other action that the merchant would like to incentivize.

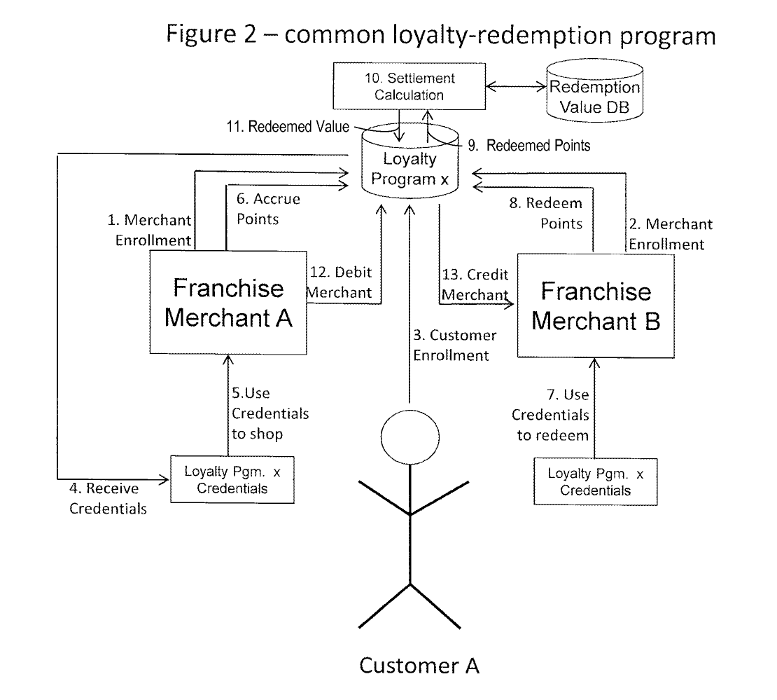

As shown in FIG. 2, a common (or shared) merchant loyalty program is provided (“Loyalty Program X”). This loyalty program is shared by a both Franchise Merchant A and Franchise Merchant B. While the merchants shown in this example are both members of the same franchise, it will be understood that the rewards and loyalty points may be shared between merchants of different franchises or merchants that are not franchisees at all. In step 1, Merchant A enrolls into Loyalty Program X. The enrollment process may include the merchant sending identification information such as name, address, phone number, email and other information. Merchant B may enroll into Loyalty Program X (in step 2) using a similar process. Customers may also enroll in Loyalty Program X using a similar enrollment process (in step 3). This enrollment process may be completed online, on a mobile device, in-person or in some other manner.

After the customer is enrolled, the customer (e.g. Customer A) receives credentials from Loyalty Program X (in step 4). The Loyalty Program X credentials may then be used by Customer A to shop at Merchant Location A (in step 5). Loyalty points may then be accrued by Merchant A using Loyalty Program X (in step 6). Customer A may use Loyalty Program X credentials to redeem loyalty points for products or services at Merchant Location B (in step 7). Loyalty points may then be redeemed by Merchant B using Loyalty Program X (in step 8). Next, redeemed loyalty points are sent to the Settlement Calculation Module (in step 10), and the Settlement Calculation Module uses the Redemption Value Database (in step 11) to convert the loyalty points to a corresponding financial value which is sent back to the Loyalty Program X. Loyalty Program X completes the value transfer process by first debiting Merchant A (in step 12) and then crediting Merchant B (in step 13). Customer A benefits from Merchant A and Merchant B participating in a common loyalty redemption program because Customer A only has to maintain a single set of loyalty program credentials and points which can accrue at one merchant and be redeemed at another participating merchant.

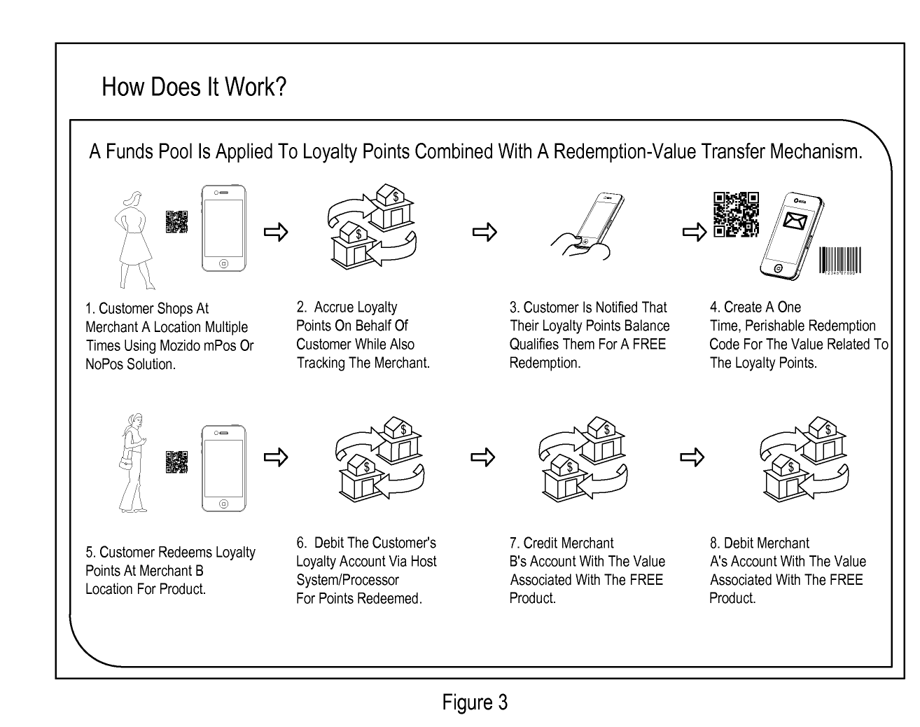

Another embodiment is shown in FIG. 3, where a rewards program is shared across a plurality of different merchants. A customer may shop, for instance, at a Merchant A location multiple times (in step 1). A cloud or other computer system may receive an indication that the customer has purchased items from Merchant A. The computer system accrues loyalty points for the customer, while also tracking how many loyalty points Merchant A gives out (in step 2). The customer is notified that they have a loyalty point balance, and that the balance is sufficient to qualify for a free item (in step 3). The computer system may then provide a (perishable) redemption code to the user reflecting an offer derived using the loyalty points accrued from the purchase at the Merchant A (in step 4). The customer then redeems the offer at another merchant (e.g. Merchant B) (in step 5). The computer system receives an indication that the user has redeemed the offer and determines the number of the loyalty points associated with the offer for one or more items at a Merchant B. The computer system debits the customer's loyalty points by the specified amount (in step 6), credits Merchant B with the value associated with the items paid for using the loyalty points (in step 7) and debits Merchant A for the value associated with the items paid for using the loyalty points (in step 8). As such, Merchant B is compensated by Merchant A for the free item given to the customer (i.e. the location where the user accrued the loyalty points).

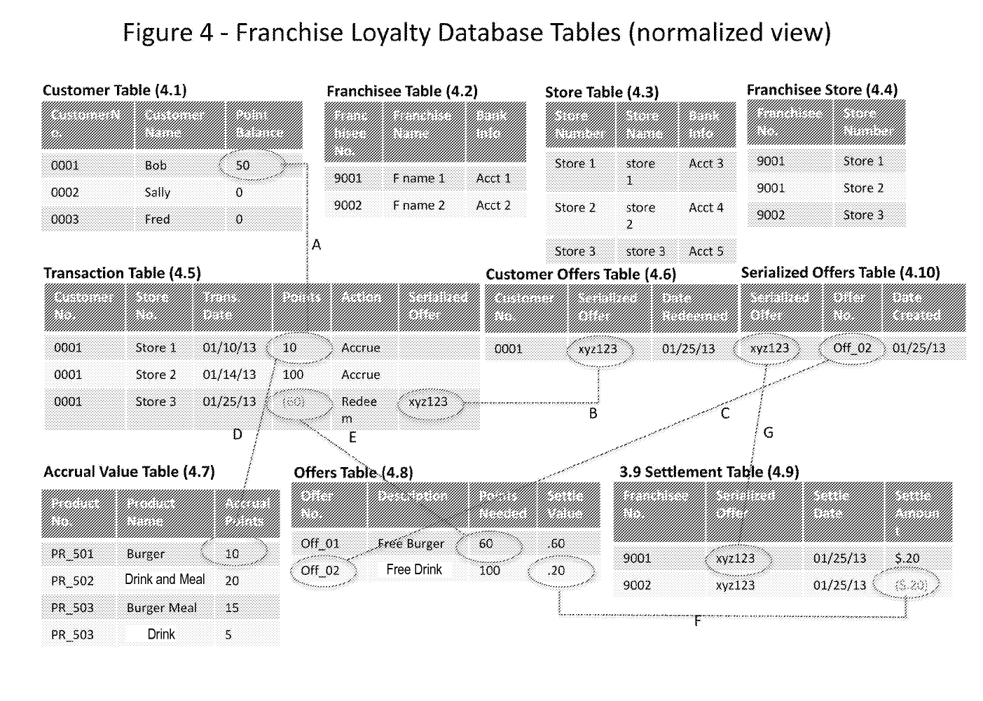

As shown in FIG. 4, embodiments described herein may be supported by a specific set of database tables that reflect various data elements and the relationships between those elements (e.g. the data model shown in FIG. 4). For example, in one embodiment, the data model of FIG. 4 may show relationships between customers, merchants (e.g. franchisees), and specific franchise stores, along with tables for transactions and loyalty points. Accordingly, Customer Table (4.1) contains a record (e.g. a row) for each enrolled customer, information about the customer including customer name, and a cumulative balance of loyalty points. The columns of table (4.1) include a column that specifies the user's unique Customer Number (i.e. a Key field), a column that specifies the customer's name, and a column to store the user's cumulative loyalty point balance. This loyalty point balance may be continually updated as events (e.g. redemption or accrual of points) occur. The point balance column in Transaction Table (4.5) may record, for each customer, the number of points accrued or redeemed for each transaction. The customer's overall point balance in Customer Table (4.1) reflects the sum of all transactions posted in Transaction Table (4.5) and is updated accordingly after each transaction.

The data model of FIG. 4 further includes Franchisee Table (4.2), Store Table (4.3) and Franchisee Store Table (4.4). The Franchisee Table (4.2) includes a record (e.g. row) for each enrolled franchise store owner, the Store Table (4.3) includes a record (e.g. row) of each participating store, and the Franchisee Store Table (4.4) includes a cross-reference between the enrolled franchisees and their participating stores. Each cross-reference relationship is reflected by a unique record in the Franchisee Store Table. Example columns of the Franchisee Table (4.2) include the Franchisee Number (the key field) and columns for the Franchise Name and Bank Account Information. Example columns of the Store Table (4.3) include the Store Number (the key field) and columns for the Store Name and Bank Account Information. Example columns of the Franchise Store Table (4.4) include the Franchisee Number and Store Number (the key fields) thereby constituting an all-key relationship for fast access.

The data model can be further described using Transaction Table (4.5), where the Transaction Table (4.5) includes a record (e.g. row) for each event that results in a loyalty point transaction for accrual or redemption. As shown, the example columns in this table include the unique Customer Number, Store Number (the key fields) along with columns to store the transaction date, point value, action, and related offers. For example, as loyalty points are periodically redeemed using values contained in Offers Table (4.8), a record is written to Transaction Table (4.5) indicating the points redeemed and the related serialized offer number. A corresponding record is written to the Customer Offers Table (4.6). The customer's point balance in Customer Table (4.1) is also updated (in this case, decremented) to reflect the number of points that were redeemed.

The data model can be further described using the Customer Offers Table (4.6), where the Customer Offers Table (4.6) contains a record (e.g. row) for each unique offer redeemed using loyalty points as discussed above in the previous step. As shown, the exemplary columns include the unique Customer Number, Serialized Offer Number (the key fields) along with columns for the date the offer was created and the date that the offer was redeemed.

The data model can be further described using the Accrual Value Table (4.7), where the Accrual Value Table (4.7) includes a record (e.g. row) for each unique product that is included in the loyalty program. As shown, the example columns include the unique Product No. (the key field) along with columns for the unique product name and the loyalty point value associated with each unique product. Accordingly, the user Bob may accrue ten loyalty points for purchasing a burger, or fifteen loyalty points for purchasing a burger meal. These points are recorded in the Transaction Table (4.5) and are further updated in the Customer Table (4.1).

The data model can be further described using the Offers Table (4.8), where the Offers Table (4.8) contains a record (e.g. row) for each unique offer that is included in the loyalty program. As shown in FIG. 4, the example columns include the unique Offer Number (the key field) along with a description of the offer, the loyalty points needed, and the financial settlement value. This settlement value may be used as the basis for compensating the stores and franchisees for redeeming loyalty program offers. The Settlement Table (4.9) includes a record (e.g. row) for each financial exchange between participating stores and franchisees. As shown, the example columns include the unique Franchisee No., the Serialized Offer Number (the key fields) the transaction date, and the settlement amount (debit or credit). Accordingly, a user may purchase items from one franchise store and receive franchise loyalty points that may be redeemed at any participating stores of that franchise loyalty program. Therefore, each franchise store is equitably compensated, regardless of where the user accrues or redeems franchise loyalty points.

The data model can be further described using the Serialized Offer Table (4.10), where in the Serialized Offer Table (4.10) includes a record (e.g. row) for each unique, redeemed offer. As shown, the exemplary columns include the unique Serialized Offer (the key field) and columns for the offer number and date created.

Still further, the data model can be described using the lines provided. Line “A” indicates that the loyalty point balance for any customer can be reconciled to the sum of points for the same customer in the Transaction Table (4.5). Line “B”, shows that the serialized offer number is posted to both the Transaction Table (4.5) and the Customer Offers Table (4.6). Line “C” indicates the relationship between the static offer from the Offers Table (4.8) and the unique serialized offer in the Serialized Offers Table (4.10). Line “D” shows the relationship between the points that are accrued in the Transaction Table (4.5) and the Accrual Value Table (4.7). The implication of Line D is that Customer 0001 purchased a quantity of 10 of product PR 501 (“Burger”) resulting in an accrual of 10 loyalty points; in practice a separate row can be written to the Transaction Table for each unique product purchased. Line “E” indicates the relationship between the loyalty points needed for an offer as reflected in Offers Table (4.8) and the redemption transaction record written in Transaction Table (4.5). Line “F”, shows the relationship between the settlement value stored in Offers Table (4.8) and the settlement amount stored in Settlement Table (4.9). Line “G”, shows the relationship between the serialized offer posted in Customer Offers Table (4.6) and the Serialized Offer Table (4.10).

In order to prevent insert and update anomalies, the data elements (e.g. columns) in each table may implement a table key value. The data model may thus store franchise and store data in such a way that ensures that all data elements are functionally dependent on the primary table key. It is important to note that the data model illustrated in FIG. 4 is only one example of a data model, and that different types and forms of data models may be used. Moreover, some tables may be combined or split based on performance and deployment requirements.

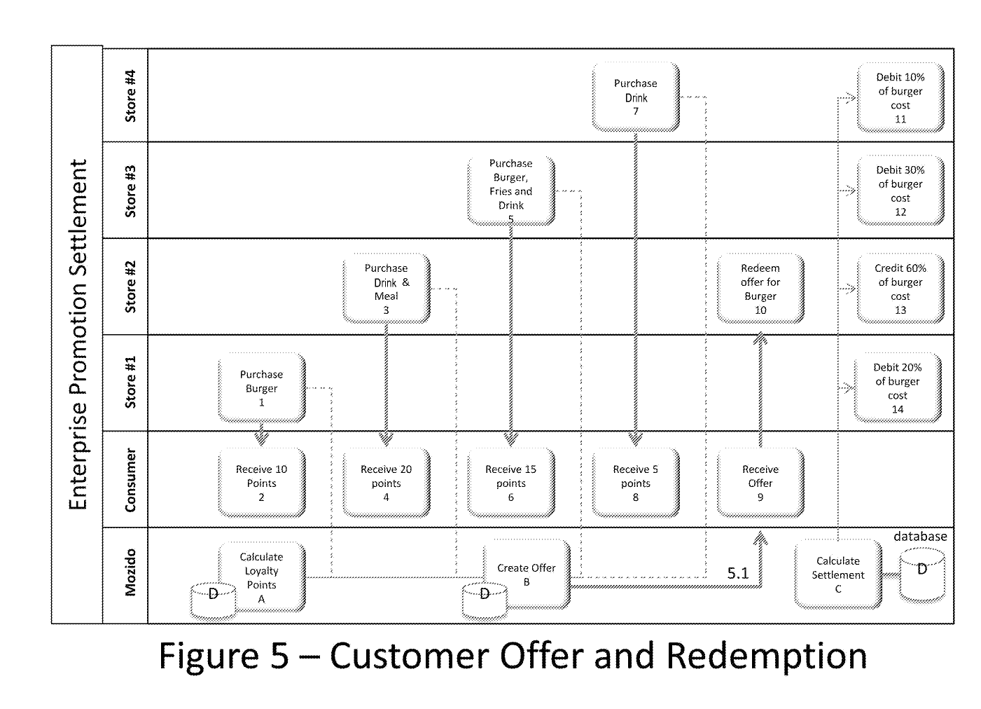

FIG. 5 illustrates a use case example where an enrolled customer shops at four separate franchise stores and later receives an offer which is redeemed at one of the stores. In Step 1, the customer shops at Store #1 and purchases a product (or performs some other action) that qualifies for loyalty points. In Step 2, the user receives 10 loyalty points based on the product record in Accrual Value Table (4.7) using the Calculate Loyalty Points Process (A). A record is written to Transaction Table (4.5) indicating the Customer Number, Store Number, Transaction Date, Points Accrued. The customer's Point Balance is updated in Customer Table (4.1) In Step 3, the customer shops at Store #2 receiving 20 loyalty points based on the product record in Accrual Value Table (4.7) using the Calculate Loyalty Points Process (A). In step 4, a record is written to Transaction Table (4.5) indicating the Customer Number, Store Number, Transaction Date, Points Accrued and any other information used by the system. The customer's Point Balance is updated in Customer Table (4.1).

In Step 5, the customer shops at Store #3 and receives 15 loyalty points based on the product record in Accrual Value Table 3.7 using the Calculate Loyalty Points Process (A). In step 6, a record is written to Transaction Table (4.5) indicating the Customer Number, Store Number, Transaction Date, Points Accrued and other info. The customer's Point Balance is updated in Customer Table (4.1). In Step 7, the customer shops at Store #4 receiving 5 loyalty points based on the product record in Accrual Value Table (3.7) using the Calculate Loyalty Points Process (A). In step 8, a record is written to Transaction Table (4.5) indicating the Customer Number, Store Number, Transaction Date, Points Accrued. The customer's Point Balance is updated in Customer Table (4.1)

In Step 9, the customer receives an offer from the Create Offers Process (B) shown using line (5.1); the offer is created based on the offer record in the Offers Table (4.8). A record is posted to the Serialized Offers Table (4.10) indicating the uniquely-serialized offer number, Offer Number from the Offers Table (4.8) and the date created. In step 10, the customer redeems the offer at Store #2. A redemption transaction is written to the Transaction Table (4.5), where the transaction includes the Customer Number, Store Number, Transaction Date, Points Redeemed, and Serialized Offer Number redeemed. Another record is posted to the Customers Offer Table (4.6) including the Customer Number, Serialized Offer Number, and Date Redeemed. The customer's Point Balance is updated in Customer Table (4.1). The Calculate Settlement Process (C), determines the financial settlement values using the Offers Table (4.8) described in FIG. 4 above.

In steps 11-14, the cost of the hamburger for which points were redeemed is spread between the various Franchise stores 1-4. A record of the net settlement between stores is recorded in the Settlement Table (4.9). Thus, in this manner, each store may be equitably compensated, regardless of where the user accrued and redeemed the points. Accordingly, in FIG. 5, if a user accrued multiple points at Store #1 for buying various items, and then redeemed those points at Store #2 without having bought anything at Store #2, the value of the redeemed points would be provided by Store #1 to Store #2 using the Franchise Loyalty Database Tables of FIG. 4.

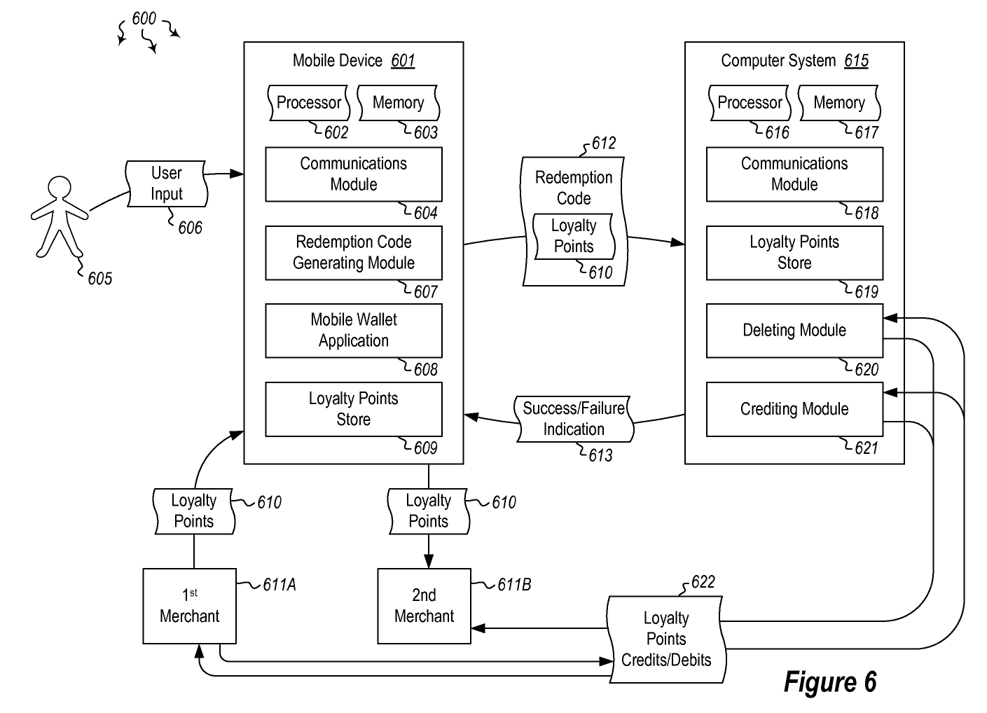

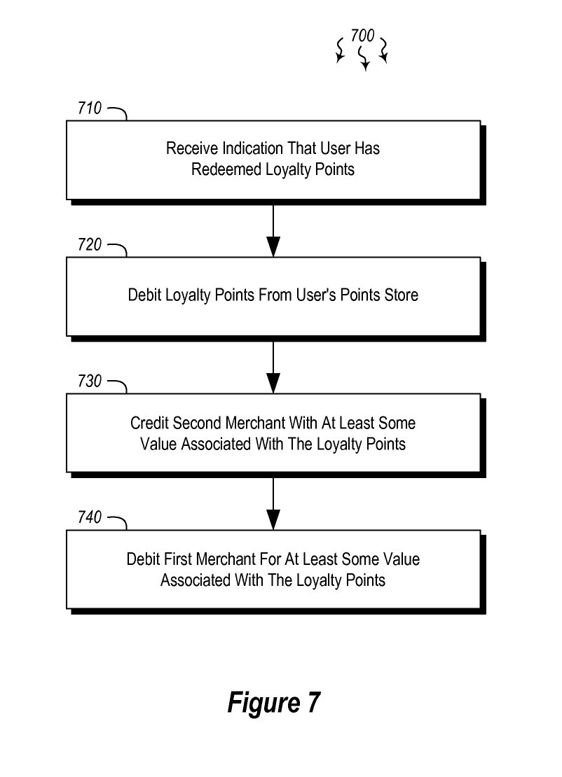

FIG. 7 illustrates a flowchart of a method 700 for sharing a loyalty and rewards program across a plurality of merchants. The method 700 will now be described with frequent reference to the components and data of environment 600 of FIG. 6.

Method 700 includes receiving an indication that a user has redeemed a specified number of loyalty points using a redemption code for one or more items at a second merchant, the user having received at least a portion of the loyalty points from a first merchant as the result of a prior purchase, the user's loyalty points being stored in loyalty points store (710). For example, computer system 615 may receive redemption code 612 or some other indication that the user 605 has redeemed (or is attempting to redeem) loyalty points 610 for one or more items at second merchant 611B. The merchant may be any type of entity that provides goods or services, and the user may be any type of purchaser or user of goods or services. The user 605 may be redeeming loyalty points to receive a discount, for example, on a clothing purchase from a clothing retailer. The user may have shopped at the retailer (e.g. the second merchant 611B) multiple times before, or may have never shopped there before. Indeed, in some cases, the user may be redeeming loyalty points at the second merchant that were received based on purchases made from a first merchant 611A. As such, the user 605 may shop at any merchant that agrees to share loyalty points, and redeem those loyalty points at any merchant that is part of the loyalty points program. Then, regardless of where the points are ultimately redeemed, each merchant that gave out the points will compensate (or be compensated) to ensure that each points providing merchant is fairly compensated.

Method 700 next includes debiting, from the user's store of loyalty points, the specified number of loyalty points redeemed by the user (720). The debiting module 620 of computer system 615 may be used to debit the user's store of loyalty points 609 by the number of points the user intends to redeem to purchase the product (or at least partially pay for the product using points). It should be noted that, while shown in mobile device 601, the user's loyalty points store 609 may be located on computer system 615 or on substantially any other computing system, whether local or remote, whether on a single computer system or distributed over multiple computer systems (e.g. stored in the cloud). Now referring to FIG. 4, it should be further noted that loyalty points (609) may be reflected in the point balance in Customer Table (4.1) and that Loyalty Points (610) may be derived from the ‘points needed’ column stored in the Offers Table (4.8). Indeed, while mobile device 601 and computer system 615 are shown with a single processor (602 and 616, respectively) and memory (603 and 617, respectively), each of these computing systems may include multiple processors, various quantities and types of memory, and may be linked to local or remote databases or other data stores. The mobile device 601 may be communicatively connected to computer system 615 via each computing system's communications module (604 and 618, respectively) and, as such, the debiting module 620 can debit loyalty points (e.g. debited loyalty points 622) from the loyalty points store 609 on mobile device 601.

Method 700 next includes crediting the second merchant with at least a portion of the value associated with the items paid for using the stored loyalty points (730). For example, as was described above in reference to FIGS. 4 and 5, the crediting module 621 of computer system 615 may credit the second merchant 611B with at least some of the value associated with the items paid for using the stored loyalty points. In the simplest case, the user 605 would have received all of his/her loyalty points from the first merchant 611A, and would redeem all of his/her loyalty points 610 at the second merchant to pay for the selected item or service. In such a case, because the second merchant would not fairly benefit from the transaction (as the user had not shopped there previously, and only redeemed points there, the second merchant will be compensated for the amount of the item by the first merchant. Accordingly, the computer system 615 will debit the first merchant's loyalty points or debit some other value store (e.g. a. monetary account) associated with the first merchant to provide adequate compensation between the two merchants. Now referring to FIG. 4, this monetary account may be reflected in the ‘Bank Info’ column within the Franchisee Table (4.2). In other cases, where multiple merchants have provided loyalty points (such as in FIG. 5 described above), each merchant is credited or debited according to the number of points given out and the number of points redeemed. Each merchant receives equal (or substantially equal) compensation from the redemption of points, regardless of where the user actually received or redeemed the points.

Method 700 further includes debiting the first merchant for at least a portion of the value associated with the items paid for using the user's stored loyalty points (740). The debiting module 620 of computer system 615 may debit the first merchant 611A for at least part of the value associated with items or services paid for using the user's stored loyalty points 610. In some cases, the computer system 615 may first receive an indication that a user has purchased items or services from the first merchant, and the computer system 615 may generate the redemption code 612 that includes loyalty points from the purchase at the first merchant and may provide the redemption code to the user. Now referring to FIG. 4, the redemption code (612) is related directly to the Serialized Offer Number stored in the Customer Offers Table (4.6) and the Serialized Offers Table (4.10). The redemption code may be generated by the mobile device 601 or by some other computer system. The redemption code itself may be a perishable code that expires after a specified amount of time. The specified amount of time may be variable and customizable, and may be set by a manger or administrative user.

The user's loyalty points store 609 may track and store the user's cumulative loyalty points. This point total may include all of the user's points combined, regardless of where were received from, and/or may include point totals from each merchant or from each group of merchants that has agreed to share loyalty points. The loyalty points store may keep a running total of points received from each merchant with which the user has done business. The loyalty points store may further include an indication of each purchase made by the user 605, along with an indication of the location at which each purchase was made and how many points were received. This embodiment is further described as Transaction Table (4.5) which comprises a history of all loyalty point transactions. Other metrics may also be kept such as average number of points received per day, per week, per merchant or group of merchants, grand total of lifetime points received, etc.

In some embodiments, the first and second merchants (611A and 611B, respectively) may be members of the same franchise. Thus, a user may shop at one particular fast food restaurant, for example, and receive loyalty points from that location. The user may then redeem those points at a different location of that same franchise. In one example, the computer system 615 may determine that the user has made purchases in multiple different franchise stores within the same franchise, and may determine, based on purchase information stored in the loyalty points store, which franchise stores the user received loyalty points from and how many points were received from each franchise store. Then, upon determining that the user has redeemed one or more loyalty points at one of the franchise stores, the crediting module 621 of computer system 615 credits the franchise stores at which the user has previously shopped and received loyalty points with at least a portion of the value of the item paid for using loyalty points. This value is proportional to the number of points given out by the franchise location. Thus, if one franchise location gave out 80% of the points that were redeemed at different franchise location for a hamburger, for example, the first franchise location would be debited for 80% (or some prorated portion) of the price of the hamburger. The reimbursement amount may be different depending on the points sharing agreement between the franchise owners. The reimbursement amount may be different for each merchant or group of merchants, and may be based on what the points were redeemed for, how the user originally got the points, whether the user is a preferred (e.g. repeat) customer, etc.

Thus, when a franchise member or other merchant reimburses another merchant, the portion of value paid to the franchise stores is proportional to the amount of loyalty points rewarded by that franchise store to the user. In some cases, the group of merchants that are in a loyalty points sharing agreement are within a specified geographic region. For example, one or more stores in a shopping mall or outdoor shopping area may choose to share loyalty points among themselves. The user's mobile device 601 may be used to determine the user's location, and thereby determine that the user is within the bounds of the shopping mall, for example. Thus, a geofence may be set up around the group of stores that share loyalty points and, whenever the user's mobile device detects that the user is within the geofence, the loyalty points may be accrued and redeemed within that merchant group. In some cases, if the user is shopping, a redemption code 612 may be generated automatically upon determining that the user has stored a sufficient number of loyalty points. That redemption codes may then be redeemed within the specified set of stores or franchises. If the redemption is successful, a success notification 613 may be sent to the user 605; similarly, if the redemption fails for some reason, a failure indication may be sent to the user. In this manner, loyalty points may be shared among merchants including franchise members or merchants that are within a specified geographic area.

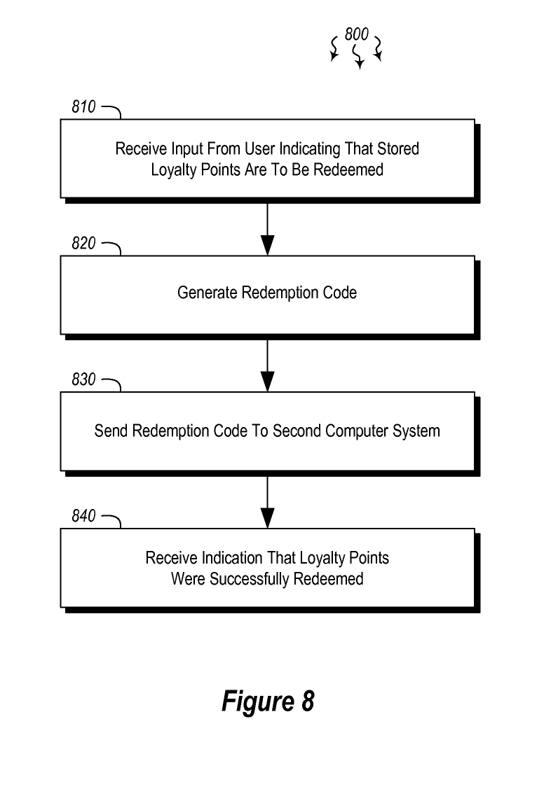

FIG. 8 illustrates a flowchart of a method 800 for sharing a loyalty and rewards program across a plurality of merchants. The method 800 will now be described with frequent reference to the components and data of environment 600 of FIG. 6.

Method 800 includes receiving an input from a user indicating that a specified number of stored loyalty points are to be used to at least partially pay for a specified item at a second merchant, wherein at least a portion of the stored loyalty points were received from a first merchant as the result of a prior purchase (810). For example, mobile device 601 may receive input 606 from user 605 indicating that loyalty points 610 stored in loyalty points store 609 are to be used to pay for all or part of a specified item or service provided by the second merchant 611B. At least in one example, some of the points redeemed were received from at least one different merchant (e.g. first merchant 611A). The redemption code generating module 607 may generate redemption code 612 (820), which includes an indication of the number of loyalty points that are to be redeemed to at least partially pay for the item or service at the second merchant 611B. The redemption code 612 may also include an indication of where each of the stored loyalty points was received (i.e from which merchant the points were received). Thus, upon receiving the indication, the computer system 615 may know how many points are being redeemed and where each of the points was received from.

Method 800 also includes sending the redemption code to a second computer system, such that the user's store of loyalty points is debited by the specified number of loyalty points, the second merchant is credited with at least a portion of the value associated with the items paid for using the stored loyalty points, and the first merchant is debited for at least a portion of the value associated with the items paid for using the user's stored loyalty points (830). Thus, mobile device 601 may send the redemption code 612 to computer system 615, where the user's store of loyalty points may be debited according to the amount of points to redeem. The debiting module 620 may debit the user's loyalty points store (whether on mobile device 601 (i.e. store 609) or on the computer system 615 (i.e. store 619)) and the crediting module 621 may credit the second merchant 611B with at least part of the value associated with the items paid for using loyalty points. Still further, the debiting module 620 may be used to debit the first merchant 611A for the proportional amount due to the second merchant, according to their points sharing agreement. The mobile device 601 may then receive indication 613 indicating that the specified number of loyalty points was redeemed and that the specified item or service is at least partially paid for (840).

In some embodiments, the user 605 may be paying for an item or service provided by a merchant using a mobile wallet application (e.g. 608). The mobile wallet application may be linked to various monetary accounts or other value stores from which the user can pay for goods or services. In some cases, loyalty points may be redeemed automatically when the user has points that are valid for the merchant, and the user is paying for goods at that merchant. Thus, if the user indicates via the mobile wallet application 608 that one or more of a merchant's goods or services are to be paid for, the user's input may cause a redemption code 612 to be generated automatically. If the user does not have sufficient loyalty points to pay for the item entirely, the mobile wallet application 608 may use a combination of payment methods to pay for the specified item including stored loyalty points and other payment methods such as money from a debit, checking, credit or other account. The mobile wallet application 608 may be executed as an application or “app” on a phone or other mobile device, and may be also be used to store the user's stored loyalty points. In this manner, a mobile device may be used to accrue and redeem loyalty points across multiple different merchants.

It should be noted that various modifications and changes may be made without departing from the spirit and scope of the present invention. For example, the system can be configured to be used by merchants irrespective of any franchise affiliation. Consequently, these and other modifications are contemplated to be within the spirit and scope of the following claims.

We claim:

1. A computer system comprising the following:
one or more processors;
system memory;
one or more computer-readable storage media having stored thereon computer-executable instructions that, when executed by the one or more processors, causes the computing system to perform a method for sharing a loyalty and rewards program across a plurality of merchants, the method comprising the following:
receiving an indication that a user has redeemed a specified number of loyalty points using a redemption code for one or more items at a second merchant, the user having received at least a portion of the loyalty points from a first merchant as the result of a prior purchase, the user's loyalty points being stored in loyalty points store;
debiting, from the user's store of loyalty points, the specified number of loyalty points redeemed by the user;
crediting the second merchant with at least a portion of the value associated with the items paid for using the stored loyalty points; and
debiting the first merchant for at least a portion of the value associated with the items paid for using the user's stored loyalty points.

2. The computer system of claim 1, further comprising:
receiving an indication that a user has purchased one or more items from the first merchant;
generating the redemption code that includes one or more loyalty points from the purchase at the first merchant; and
providing the redemption code to the user.

3. The computer system of claim 1, wherein the redemption code is a perishable code that expires after a specified amount of time.

4. The computer system of claim 1, wherein the loyalty points store tracks the user's cumulative loyalty points, and further tracks loyalty points for each merchant at which the user has done business.

5. The computer system of claim 4, wherein the loyalty points store includes an indication of each purchase made by the user, along with an indication of the location at which each purchase was made.

6. The computer system of claim 1, wherein the first and second merchants are members of the same franchise.

7. The computer system of claim 6, further comprising:
determining that the user has made purchases in a plurality of different franchise stores within the franchise;
determining, based on purchase information stored in the loyalty points store, which franchise stores the user received loyalty points from and how many points were received from each franchise store; and
upon determining that the user has redeemed one or more loyalty points at one of the franchise stores, crediting one or more of the franchise stores with at least a portion of the value of the item paid for using loyalty points.

8. The computer system of claim 7, wherein the portion of value paid to the franchise stores is proportional to the amount of loyalty points rewarded by that franchise store to the user.

9. The computer system of claim 1, wherein redemption codes are generated automatically upon determining that the user has stored a sufficient number of loyalty points.

10. The computer system of claim 1, wherein redemption codes are redeemable in a specified set of stores.

11. The computer system of claim 10, wherein the specified set of stores is defined by and enforced using geofencing.

12. A computer program product for implementing a method for sharing a loyalty and rewards program across a plurality of merchants, the computer program product comprising one or more computer-readable storage media having stored thereon computer-executable instructions that, when executed by one or more processors of the computing system, cause the computing system to perform the method, the method comprising:
receiving an input from a user indicating that a specified number of stored loyalty points are to be used to at least partially pay for a specified item at a second merchant, wherein at least a portion of the stored loyalty points were received from a first merchant as the result of a prior purchase;
generating a redemption code that is configured to redeem the specified number of loyalty points to at least partially pay for the specified item at the second merchant;
sending the redemption code to a second computer system, such that the user's store of loyalty points is debited by the specified number of loyalty points, the second merchant is credited with at least a portion of the value associated with the items paid for using the stored loyalty points, and the first merchant is debited for at least a portion of the value associated with the items paid for using the user's stored loyalty points;
receiving an indication that the specified number of loyalty points was redeemed and that the specified item is at least partially paid for.

13. The computer program product of claim 12, wherein the input indicating that a specified number of stored loyalty points are to be used to at least partially pay for a specified item is generated automatically upon determining that the user has initiated a payment using a mobile wallet application.

14. The computer program product of claim 13, wherein the mobile wallet application uses a combination of payment methods to pay for the specified item including at least the specified number of stored loyalty points and one other payment method.

15. The computer program product of claim 13, wherein the mobile wallet application is running on a mobile computing device.

16. The computer program product of claim 13, wherein the mobile wallet application is used to store the user's stored loyalty points.

17. At a computer system including at least one processor and a memory, a computer-implemented method for sharing a loyalty and rewards program across a plurality of merchants, the method comprising:
receiving an indication that a user has redeemed a specified number of loyalty points using a redemption code for one or more items at a second merchant, the user having received at least a portion of the loyalty points from a first merchant as the result of a prior purchase, the user's loyalty points being stored in loyalty points store;
debiting, from the user's store of loyalty points, the specified number of loyalty points redeemed by the user;
crediting the second merchant with at least a portion of the value associated with the items paid for using the stored loyalty points; and
debiting the first merchant for at least a portion of the value associated with the items paid for using the user's stored loyalty points.

18. The method of claim 17, further comprising:
receiving an indication that a user has purchased one or more items from the first merchant;
generating the redemption code that includes one or more loyalty points from the purchase at the first merchant; and
providing the redemption code to the user.

19. The method of claim 17, wherein the first and second merchants are members of the same franchise.

20. The method of claim 19, further comprising:
determining that the user has made purchases in a plurality of different franchise stores within the franchise;
determining, based on purchase information stored in the loyalty points store, which franchise stores the user received loyalty points from and how many points were received from each franchise store; and
upon determining that the user has redeemed one or more loyalty points at one of the franchise stores, crediting one or more of the franchise stores with at least a portion of the value of the item paid for using loyalty points.
